(19) United States
(12) Patent Application Publication
(10) Pub. No.: US 2018/0054986 A1
(43) Pub. Date: Mar. 1, 2018

(54) PLANT WATER CULTURE FRAME AND PLANT GROWTH ENVIRONMENT ENSURING SYSTEM

(71) Applicants: BOE TECHNOLOGY GROUP CO., LTD., Beijing (CN); BOE OPTICAL SCIENCE AND TECHNOLOGY CO., LTD., Jiangsu (CN)

(72) Inventors: Aili FU, Beijing (CN); Hao SU, Beijing (CN); Jiefei WU, Beijing (CN); Qingyang ZHAO, Beijing (CN); Zhongyu HAN, Beijing (CN); Qing QIN, Beijing (CN)

(21) Appl. No.: 15/528,790

(22) PCT Filed: Jun. 6, 2016
(86) PCT No.: PCT/CN2016/084904

§ 371 Date: May 23, 2017

(30) Foreign Application Priority Data
Mar. 25, 2016 (CN) 201610177556.7

(51) Int. Cl. A01G 31/06; A01G 31/04

(52) U.S. Cl. CPC A01G 31/06; A01G 7/045; A01G 31/04

(57) ABSTRACT

A plant water culture frame and a plant growth ensuring system are disclosed. The plant water culture frame includes a frame body provided with at least one water culture space layer; at least one culture tray provided in the water culture space and used for containing nutrient solution; a plant-fixed basket support component provided in the culture tray and supporting a plant-fixed basket to make it floating with the nutrient solution; and at least one plant-fixed basket provided on the plant-fixed basket support component. The embodiments of the present disclosure effectively avoid having the plant root system submerged when the liquid level of the nutrient solution is too high.

### RELATED APPLICATIONS

The present application is the U.S. national phase entry of PCT/CN2016/084904, with an international filing date of Jun. 6, 2016, which claims the benefit of Chinese Patent Application No. 201610177556.7, filed on Mar. 25, 2016, the entire disclosure of which are incorporated herein by reference.

### TECHNICAL FIELD

The present disclosure relates to the technical field of agriculture culture facilities, and in particular to a plant water culture frame and a plant growth environment ensuring system.

### BACKGROUND

At present, most of vegetables are still cultured in soil. Due to less and less cultivated land area and more and more serious pollution, it has become a desire of the majority of people to eat pollutant-free vegetables. Many people began to culture vegetables in the balcony, but it is still very inconvenient to culture in soil since it occupies a large area and is difficult to guarantee adequate sunshine.

In the plant culture, soilless culture techniques are often used. Soilless culture is a modern seedling culture technique which uses light materials, such as peat, forest leaf mold, or expanded vermiculite, as a seedling culture substrate to fix plants so that plant root systems directly contact with nutrient solution, and which uses accurate mechanization seeding to form seedlings once. Selected seedling tray is divided into grids each carrying one seed and thus forming one seedling, and the substrate intertwines with the formed seedling′ root system that has a shape of a plug with big top and small bottom, which is generally called tray-soilless seedling culture.

Water culture is one of soilless cultures, which acclimatizes ordinary plants and flowers with modern biological engineering technology by physical, chemical, biological engineering means without use of natural soil. The plant root systems directly contact with the nutrient solution. Water culture separates the plant root systems from soil so that it can avoid a variety of soil-borne diseases, and there is no need for soil disinfection. Plants cultured in this method absorb nutrition directly from the solution. Thus, fibrous roots of a corresponding root system are developed, and main roots thereof are significantly degraded relative to the open field culture. The soil is replaced with the nutrient solution, with advantages of convenient care, cheap price, cleanness, healthy growth of flowers and leaves, and the like. Water culture mixes nutrient solution depending on requirements for plant growth, and makes it to be absorbed directly by plants. It has characteristics of cleanness and no-pests, and is widely accepted by urban residents.

### SUMMARY

In a exemplary embodiment, a plant water culture frame is provided herein that has a frame body provided with at least one water culture space layer; at least one culture tray provided in the water culture space and used for containing nutrient solution; a plant-fixed basket support component provided in the culture tray and supporting a plant-fixed basket to make it floating with the nutrient solution; and at least one plant-fixed basket provided on the plant-fixed basket support component.

In certain exemplary embodiments, the plant-fixed basket support component comprises a plurality of through-holes, and the plant-fixed basket is placed on the plant-fixed basket support component by making the bottom of the plant-fixed basket passing through the through-hole.

In certain exemplary embodiments, an area of a cross-section of the plant-fixed basket support component is equal to that of an opening of the culture tray, and the plant-fixed basket support component is an opaque flat plate.

In certain exemplary embodiments, the plant-fixed basket support component is a foam plate.

In certain exemplary embodiments, the plant water culture frame further comprises a seed support component provided within the plant-fixed basket for obtaining moisture from the culture tray and supporting seeds placed within the seed support component so as to facilitate seed germination.

In certain exemplary embodiments, a seed clamped portion is provided in the seed support component, and the seed clamped portion is configured as a gap penetrating the seed support component.

In certain exemplary embodiments, a seed clamped portion is provided in the seed support component, and the seed clamped portion includes a recess disposed in the seed support component and a gap disposed at the recess and penetrating the seed support component.

In certain exemplary embodiments, a cross-section of the gap is cross-shaped.

In certain exemplary embodiments, the seed support component is a sponge block.

In certain exemplary embodiments, the plant-fixed basket comprises a neck portion and a waist portion, and the waist portion is a hollowed-out structure comprising a plurality of support posts.

In certain exemplary embodiments, a height ratio of the neck portion to the waist portion is between 1:2 and 1:3.

In certain exemplary embodiments, a height ratio of the plant-fixed basket to the plant-fixed basket support component is larger than 1.1:1 or less than 1.5:1.

In certain exemplary embodiments, a lighting fixture simulating a wavelength of sunlight is provided on the top of the water culture space.

In certain exemplary embodiments, the lighting fixture comprises a white LED light source coated with red phosphor.

In a second aspect, a plant growth ensuring system for use in the plant water culture frame as described above is provided herein that has a parameter sensor provided in the culture tray of the plant water culture frame for detecting a parameter of a plant growth environment in the culture tray; a growth environment regulation system for regulating the plant growth environment in the culture tray; and a controller, wherein the parameter sensor and the growth environment regulation system are connected to the controller, and the controller generates a growth environment adjustment command according to a growth environment parameter sensed by the parameter sensor so as to control the growth environment regulation system to adjust the plant growth environment in the culture tray.

In certain exemplary embodiments, the parameter sensor comprises one or more of a water temperature sensor, a water level sensor, an oxygen content sensor, a nutrient solution concentration sensor, a light sensor, and an image acquiring device.

In certain exemplary embodiments, the growth environment regulation system comprises an air supply system including an air supply pipe provided at the culture tray; an air pump is provided at the air supply pipe; and the controller is connected to the air pump for controlling the air pump to introduce oxygen into the culture tray.

In certain exemplary embodiments, the parameter sensor comprises an oxygen content sensor, and when the oxygen content sensor detects that the oxygen content in the nutrient solution within the culture tray is below a limit threshold, the air supply system would automatically turn on the air pump for oxygen supply.

In certain exemplary embodiments, the growth environment regulation system comprises a nutrient solution supply system including a nutrient solution supply pipe provided at the culture tray; a nutrient solution mixture supply device is provided at the nutrient solution supply pipe; and the controller is connected to the nutrient solution mixture supply device for controlling the nutrient solution mixture supply device to mix the nutrient solution and to supply the nutrient solution to the culture tray.

In certain exemplary embodiments, the plant growth ensuring system further comprises a communication unit; and wherein the controller is connected to a host computer through the communication unit; the controller receives parameter information of the parameter sensor and transmits the parameter information to the host computer through the communication unit; the host computer transmits to the controller through the communication unit a growth environment adjustment command generated according to the parameter information; and the controller receives the growth environment adjustment command of the host computer to control the growth environment regulation system to adjust the plant growth environment in the culture tray.

### BRIEF DESCRIPTION OF DRAWINGS

In order to more clearly explain technical solutions in the embodiments of the present disclosure, the drawings to be used in the description of the embodiments are briefly introduced below. It is apparent that the drawings in the following description are some embodiments of the present disclosure, and that other drawings may be derived by those ordinary skills in the art from these drawings without undue experimentation.

FIG. 1 is a schematic structural diagram of a plant water culture frame in an embodiment of the present disclosure;

FIG. 2 is a schematic structural diagram of a plant water culture frame in another embodiment of the present disclosure;

FIG. 3 is a schematic structural diagram of a culture tray in an embodiment of the present disclosure;

FIG. 4 is a schematic structural longitudinal-section view of a culture tray in an embodiment of the present disclosure;

FIG. 5 is a schematic structural diagram of a plant-fixed basket in an embodiment of the present disclosure;

FIG. 6 is a schematic top view of a seed support component in an embodiment of the present disclosure;

FIG. 7 is a schematic structural longitudinal-section view of the seed support component of FIG. 6 in the A-A direction;

FIG. 8 is a schematic top view of a seed support component in an embodiment of the present disclosure;

FIG. 9 is a schematic structural longitudinal-section view of the seed support component of FIG. 8 in the B-B direction; and

FIG. 10 is a schematic structural diagram of a plant growth ensuring system in an embodiment of the present disclosure.

### DETAILED DESCRIPTION OF EMBODIMENTS

In order to make objects, technical solutions and advantages of the embodiments of the present disclosure clearer, the technical solutions in the embodiments of the present disclosure will be clearly and completely described below in connection with the accompanying drawings in the embodiments of the present disclosure. It is apparent that the described embodiments are parts of, but not all of the embodiments of the present disclosure. All other embodiments derived by those ordinary skills in the art based on the embodiments of the present disclosure without undue experimentation fall within the protected scope of the present disclosure.

In the current water culture methods, plants are basically fixed in a plant loaded tray, which is not conducive to plant growth. Also, when a liquid level of nutrient solution in a water culture tray is too high, it is easy for the nutrient solution to overflow the plant loaded tray to submerge plant roots, thus affecting normal growth of the plants.

The technical problem to be solved by the present disclosure is how to guarantee that the nutrient solution does not submerge the plant roots when the liquid level of the nutrient solution in the water culture tray rises.

With respect to the drawbacks of the prior art, the present disclosure provides a plant water culture frame and a plant growth environment ensuring system, which can effectively ensure to keep height of the plant roots under the liquid level of the nutrient solution unchangeable when the liquid level of the nutrient solution in the water culture tray rises.

A plant water culture frame and a plant growth ensuring system provided in embodiments of the present disclosure provide a plant-fixed basket support component which supports a plant-fixed basket to make it floating with nutrient solution, so as to keep plant root systems always in contact with the nutrient solution as a height of a liquid level of the nutrient solution changes. This effectively avoids that, when the liquid level of the nutrient solution is too high, the plant root systems are submerged, thus affecting normal growth of plants.

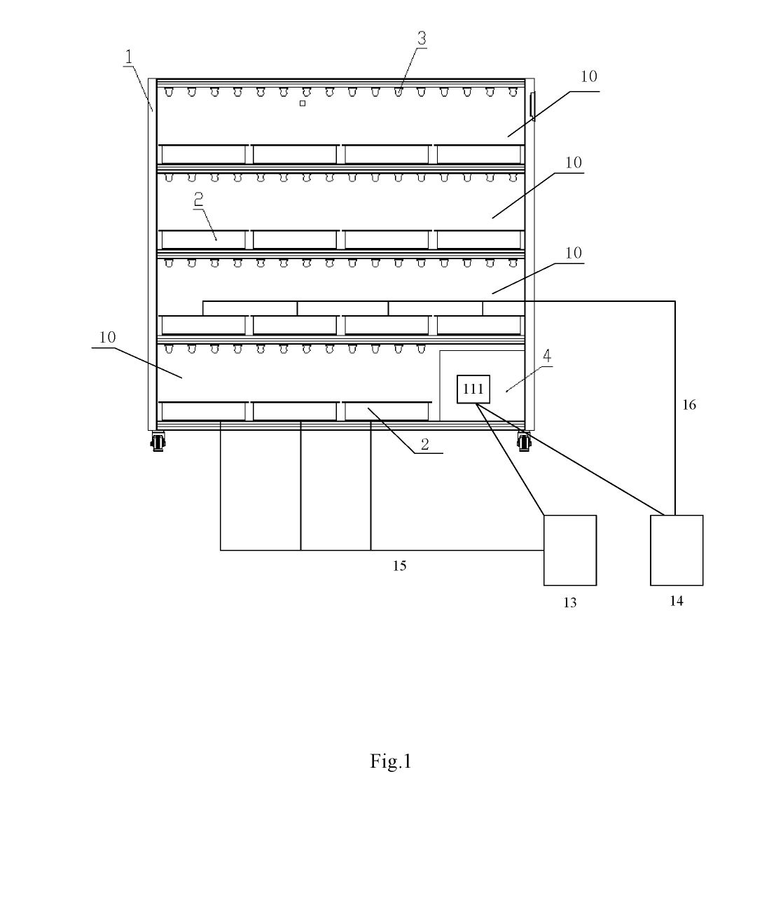

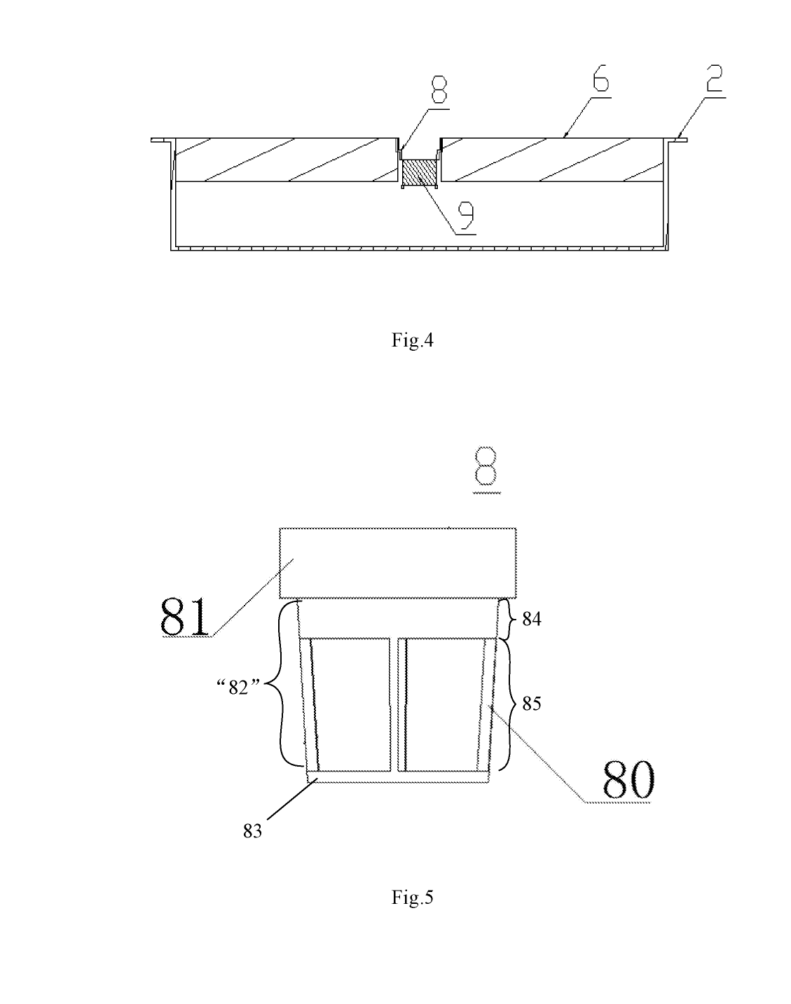

A plant water culture frame as shown in FIG. 1 is provided herein that comprising: a frame body 1 provided with at least one water culture space layer 10 (in FIG. 1, illustrated as four water culture space layers); at least one culture tray 2 provided in the water culture space 10 for containing nutrient solution; and a plant-fixed basket support component 6 that is provided in the culture tray 2 and supports a plant-fixed basket 8 as shown in FIG. 5 to make it floating with the nutrient solution, as shown in FIGS. 3 and 4. As shown in FIGS. 3 and 4, at least one plant-fixed basket 8 is provided on the plant-fixed basket support component 6. A seed support component 9 is provided within the plant-fixed basket 8 for obtaining moisture from the culture tray 2 and supporting a seed placed in the seed support component 9, so as to facilitate seed germination. The plant water culture frame of the present disclosure will be illustrated in detail below.

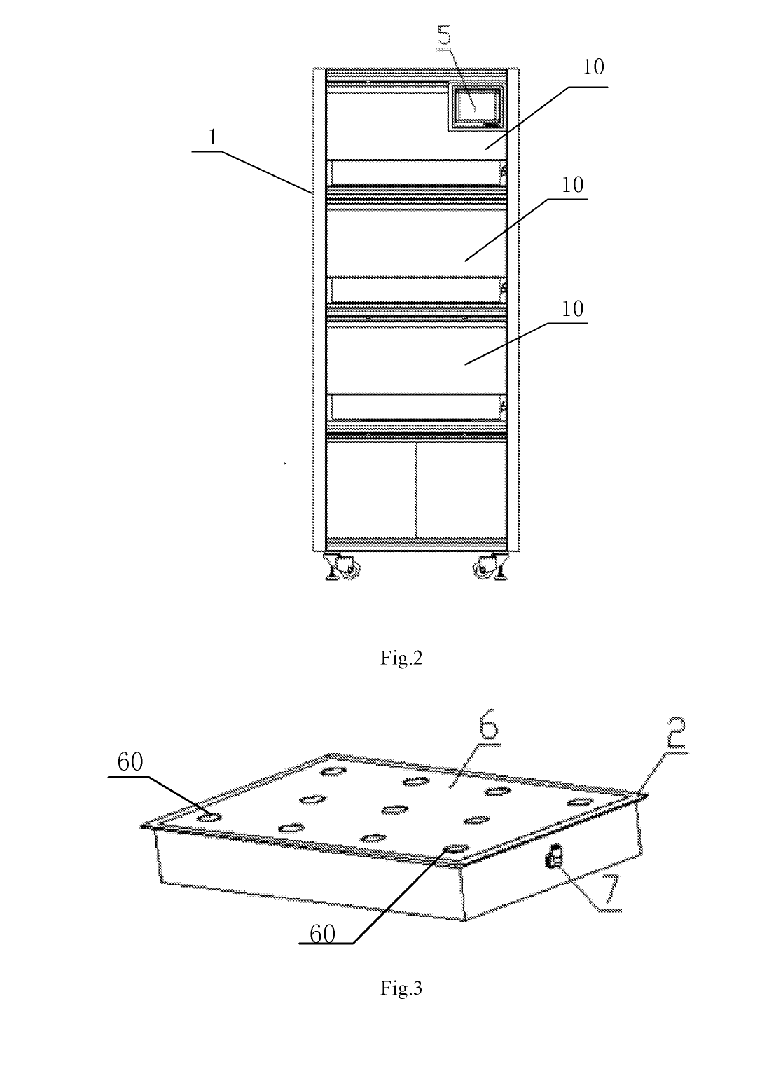

As shown in FIGS. 1 and 2, in the present disclosure, the water culture space 10 in the frame body 1 can be provided according to actual situations. A corresponding number of water culture space layers 10 can be provided according to height of actual space. Four water culture space layers 10 are shown in FIG. 1 and three water culture space layers 10 are shown in FIG. 2. One or more culture trays 2 may be selected in each water culture space layer 10 depending on the types and sizes of plants to be planted. As shown in FIGS. 3 and 4, a plant-fixed basket support component 6 is provided in the culture tray 2 and at least one plant-fixed basket 8 is provided in the plant-fixed basket support component 6. By providing the plant-fixed basket support component 6 in the culture tray 2, not only the plant-fixed basket 8 can be supported to float with the nutrient solution, but also it is to be ensured that a position of the plant-fixed basket in the culture tray 2 is relatively stable.

As shown in FIGS. 3 and 4, in some embodiments, in order to avoid nutrient solution of water culture produces cyanobacteria during culture of plants due to receipt of light and bacteria, an area of a cross section of the plant-fixed basket support component 6 is equal to that of an opening of the culture tray 2 and the plant-fixed basket support component 6 is an opaque flat plate. In this way, it is to be ensured that the nutrient solution in the culture tray is free from sunlight while the plant-fixed basket support component 6 freely floats up and down in the culture tray 2. This prevents producing cyanobacteria or causing the nutrient solution to breed bacteria, and prevents reducing oxygen content and nutrient in the nutrient solution. In some embodiments, the plant-fixed basket support component 6 is a foam plate and a coated plate which are easy to process and has a low cost.

As shown in FIG. 3, the plant-fixed basket support component 6 includes a plurality of through-holes 60, and the plant-fixed basket 8 is placed on the plant-fixed basket support component 6 by making the bottom of the plant-fixed basket 8 passing through the through-hole 60. It is to be noted again that the through-holes 60 of the present disclosure may be differently provided depending on types of plants to be planted. When culturing small plants, a plurality of through-holes 60 may be provided in the plant-fixed basket support component 6 so as to place a plurality of plant-fixed baskets 8 accordingly. In general, one plant-fixed basket 8 is placed in each through-hole 60. When culturing big plants, the number of through-holes 60 can be appropriately reduced and less plant-fixed baskets 8 can be provided relative to culturing small plants. As such, it is to be ensured that each plant can absorb sufficient nutrient solution while effectively ensuring light, thus effectively promoting growth of plants. The density of the through-holes 60 determines the density and daylighting of plants to be cultured. As shown in FIG. 4, in order to ensure that the plant-fixed basket support component 6 drives the plant-fixed basket 8 to float up and down while it floats up and down with change of the height of the nutrient solution, an aperture of the through-hole 60 is set in accordance with an outer diameter of the plant-fixed basket 8 and shape of the through-hole 60 matches with that of the planted-fixed basket 8. This allows the plant-fixed basket 8 to be placed in the through-hole 60 exactly without any other remaining voids. The outer diameter of the plant-fixed basket 8 is slightly larger than the aperture of the through-hole 60, so that when the plant-fixed basket 8 is mounted on the plant-fixed basket support component 6, it can be exactly caught in the through-hole 60 so as to float up and down with the plant-fixed basket support component 6. When spacing between the through-holes 60 in the plant-fixed basket support component 6 is smaller, plants cultured in each water culture space layer 10 is more. This is used in an early stage of seedling culture to effectively save space. When spacing between the through-holes 60 in the plant-fixed basket support component 6 is bigger, the number of plants cultured in each water culture space layer 10 is relatively reduced. This is used in later stages of plant growth to increase a culture space of plants so as to facilitate growth. In some embodiments, the spacing between the through-holes 60 in the plant-fixed basket support component 6 may be set in different sizes depending on types of plants, so as to use the space more efficiently. In addition, the plant growth stages can be further subdivided. Especially for plants with a longer growing season, different spacings between holes may be designed for different growing seasons to effectively use space for plant culture.

As shown in FIG. 4, in order to further ensure that cultured plants are not immersed in the nutrient solution excessively while the plant-fixed basket 8 floats up and down with the plant-fixed basket support component 6, the height of the plant-fixed basket 8 is roughly equal to that of the plant-fixed basket support component 6. In some embodiments, a height ratio of the plant-fixed basket 8 to the plant-fixed basket support component 6 is larger than 1.1:1. In some other embodiments, the height ratio of the plant-fixed basket 8 to the plant-fixed basket support component 6 is less than 1.5:1. In this way, not only seeds or plants placed in the plant-fixed basket 8 can contact the nutrient solution at its bottom so as to promote growth, but also the seeds or plants may be free from rotting caused by excessive immergence in the nutrient solution.

According to the present disclosure, the plant-fixed basket 8 is a hollow structure similar to a non-covered cup. Specifically, as shown in FIG. 5, the plant-fixed basket 8 includes a neck portion 81, a waist portion 82, and a bottom portion 83. In some embodiments, a height ratio of the neck portion 81 to the waist portion 82 is 1:1. In some other embodiments, the height ratio of the neck portion 81 to the waist portion 82 is between 1:2 and 1:3. As shown in FIG. 5, the neck portion 81 is generally wider than the waist portion 82 and bottom portion 83 for contacting with the plant-fixed basket support component 6 so that the plant-fixed basket 8 is effectively fixed within the through-hole 60 in the plant-fixed basket support component 6. In addition, as shown in FIG. 5, the waist portion 82 includes a non-hollowed-out solid part 84 as the neck portion 81 and a hollowed-out part 85. The hollowed-out part 85 includes a plurality of support posts 80 which are separated from each other and collect the solid part 84 and the bottom portion 83. The solid part 84 can increase strength of connection between the bottom portion and the neck portion and balance support forces of the different support posts 80 to some extent. Also, the hollowed-out part 85 including the plurality of support posts 80 can effectively ensure that plant root systems can extend out from the hollowed-out structure (i.e. gaps between the support posts 80) into the nutrient solution in the culture tray 2 for growth. In some embodiments, the number of support posts 80 may be three, four, five, six, or more. By means of the above, the plant-fixed basket 8 can be effectively fixed within the through-hole 60 in the plant-fixed basket support component 6 while it is to be effectively ensured that plants sufficiently contact with the nutrient solution.

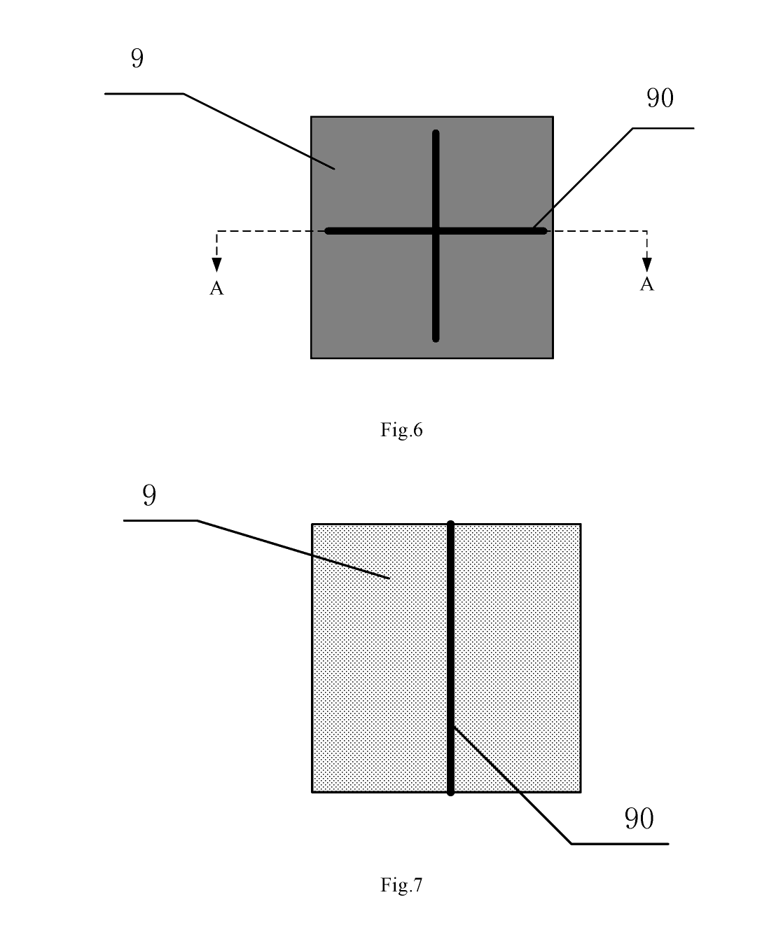

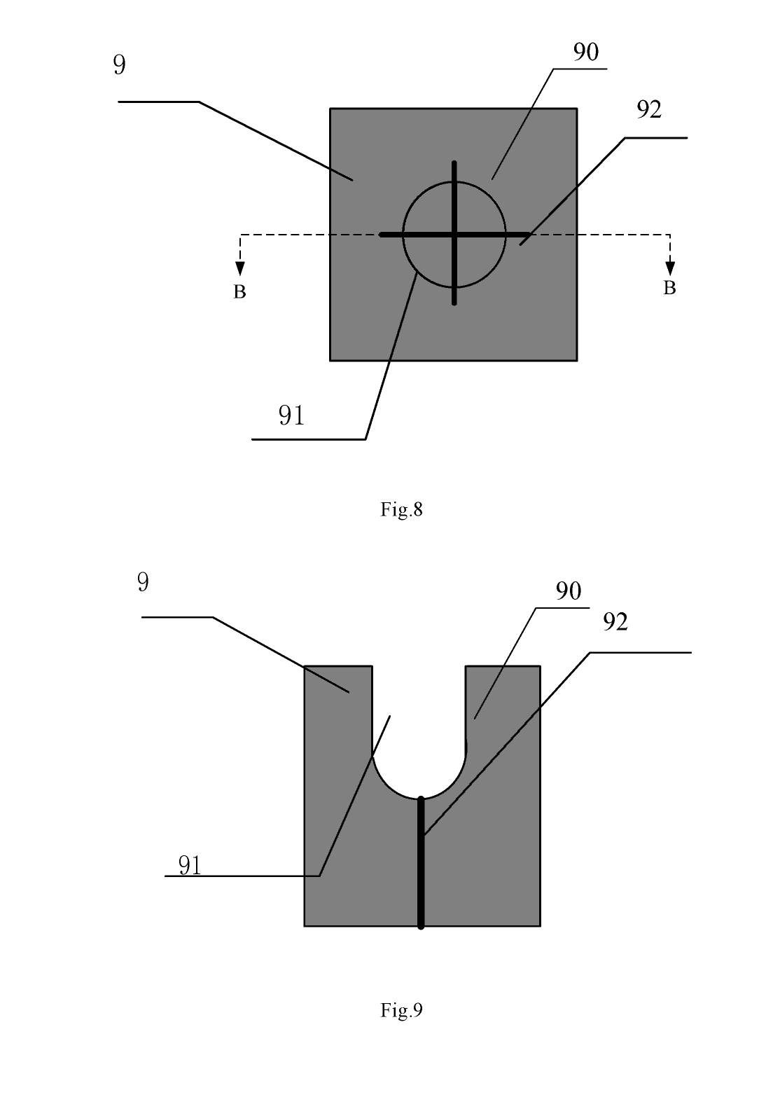

In some embodiments, a seed support component 9 is provided within the plant-fixed basket 8 that is generally located at the waist portion 82 of the plant-fixed basket 8. As shown in FIGS. 6 to 9, a seed clamped portion 90 is provided in the seed support component 9 that is used for supporting and clamping a seed during an initial stage of seed culture so as to make it contacting with the nutrient solution to germinate. As shown in FIGS. 6 and 7, in order to enable the seed support component 9 adapting germination of seeds of various different types and sizes, the seed clamped portion 90 is configured as a gap penetrating the seed support component 9 as shown in FIG. 7. As shown in FIG. 6, a cross-section of the gap is set to a cross shape. In other embodiments, the cross-section of the gap may be set to a “−” shape. As another embodiment of the present disclosure, unlike the seed clamped portion as shown in FIGS. 6 and 7, the seed clamped portion 90 includes a recess 91 disposed in the seed support component 9 and a gap 92 disposed at the recess 91 and penetrating the seed support component 9, as shown in FIGS. 8 and 9. As shown in FIG. 8, a cross-section of the gap 92 is of a cross shape. In this way, it can not only ensure germination of bigger seeds, but also is applicable to germination of smaller seeds. As shown in FIGS. 8 and 9, the upper half of the recess 91 is a cylinder shape and the lower half thereof is a hemisphere shape. The cross-section of the upper half of the recess 91 is configured as a circular shape, which is more conducive to germination and growth of plant seedlings. It will be appreciated by those skilled in the art that the recess 91 may be of any other suitable shape. Compared with the prior art, it is more convenient to place various kinds of seeds in the seed support component 9 provided by the embodiments of the present disclosure, and the seed support component 9 is more conducive to longitudinal growth of plant seedlings at the initial stage of seed germination. It is easier for a structural design of the gap penetrating the seed support component 9 to make seeds and roots growing longitudinally downwardly. In some embodiments of the present disclosure, the seed support component 9 is configured to be made of an easily hydrophil and breathable material. In some embodiments, the seed support component 9 is made of sponge blocks so as to save costs.

As shown in FIG. 1, in order to further ensure cultured plants may still grow normally in a poor light environment, at least one lighting fixture 3 that simulates a wavelength of sunlight is provided on the top of the water culture space 10. In some embodiments, the lighting fixture 3 is a LED lamp that can simulate a sunlight exposure environment. In some embodiments, 12 LED lamps are provided in each water culture space layer. The lighting fixture 3 comprises a white LED light source coated with red phosphor.

Plant photosynthesis requires wavelengths in the range of 400 nm to 720 nm. Blue light at wavelengths of 400 nm to 520 nm and red light at wavelengths of 610 nm to 720 nm have the greatest effect on the plant photosynthesis. Traditional plant growth lamps only use red/blue LED mixed light, which lacks of other color spectrum and whose color is not suitable for human eyes' observation. The conventional LED light source contains more blue light and less red light. The present disclosure increases red phosphor in the white LED light source so that the red light and blue light is high in the spectrum of the light emitted from the LED light source according to the present disclosure, and the LED light source emits light in the whole spectrum. Thus, the white LED light source according to the present disclosure not only satisfies the demand for promoting plant photosynthesis, but also can be applicable to human eyes' observation to facilitate personnel operation.

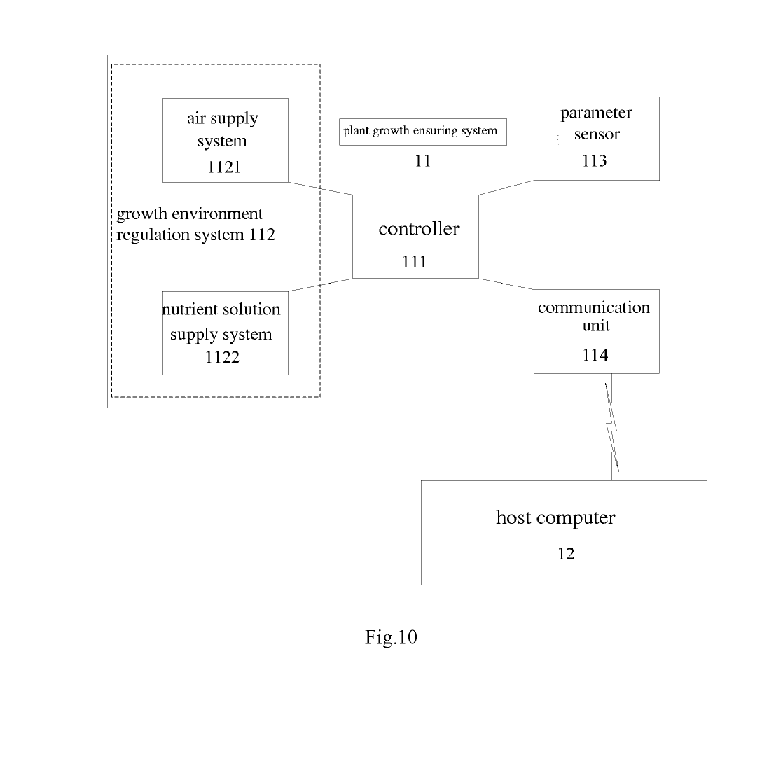

To further embody superiority of the plant water culture frame provided by the present disclosure, the present disclosure also provides a plant growth ensuring system suitable for the above plant water culture frame. As shown in FIG. 10, the system 11 includes a controller 111, a growth environment regulation system 112, and a parameter sensor 113. The growth environment regulation system 112 and the parameter sensor 113 are connected to the controller 111. The parameter sensor 113 is disposed in the culture tray 2 as shown in FIG. 1. The parameter sensor 113 is used to detect parameters of the plant growth environment. The controller 111 generates a growth environment adjustment command according to the growth environment parameters sensed by the parameter sensor 113 to control the growth environment regulation system 112 to adjust the plant growth environment. The plant growth ensuring system provided by the present disclosure is illustrated in detail below.

In embodiments of the present disclosure, types and quantity of the parameter sensors 113 may be appropriately configured depending on types of the plants and plant growth parameters to be acquired. For example, if there is a need to detect a temperature of the nutrient solution, a water temperature sensor is provided in the culture tray 2. If there is a need to detect a liquid level of the nutrient solution, a water level sensor is provided at a corresponding position of the culture tray 2. If there is a need to detect oxygen content of the nutrient solution, an oxygen content sensor is provided in the culture tray 2. If there is a need to detect composition concentration of the nutrient solution, a nutrient solution concentration sensor is provided in the culture tray 2. If there is a need to detect light intensity of the plant growth environment, a light sensor is provided in the culture space. If there is a need to detect a growth period of plants, an image acquiring device is provided in the water culture space to obtain the growth period of the plants. In summary, various sensors that can sense the plant growth environment or plant growth conditions can be used in the present disclosure. By providing the above-mentioned various parameter sensors, growth status of plants can be obtained in real time, so as to determine whether indicators of the plant growth environment are achieved.

As shown in FIG. 10, the growth environment regulation system 112 includes an air supply system 1121. The air supply system 1121 includes an air supply pipe 15 arranged to reach the culture trays 2 as shown in FIG. 1, which enters into the internal of the culture trays 2 through, for example, through-holes 7 in the culture tray 2 as shown in FIG. 3. An air pump 13 is provided at the air supply pipe 15, and the controller 111 is connected to the air pump 13 for controlling the air pump 13 to introduce oxygen into the culture trays 2. When an oxygen content sensor detects that oxygen content in the nutrient solution is below a limit threshold, the air supply system 1121 will automatically turn on the air pump 13 for oxygen supply. Although the air supply pipe 15 is only shown schematically in FIG. 1 to reach parts of the culture trays 2, it will be appreciated by those skilled in the art that the air supply pipe 15 may reach any or all of the culture trays 2.

Further, as shown in FIG. 10, the growth environment regulation system 112 further includes a nutrient solution supply system 1122. The nutrient solution supply system 1122 includes a nutrient solution supply pipe 16 arranged to reach the culture trays 2 as shown in FIG. 1, which enters into the internal of the culture trays 2 through, for example, through-holes 7 in the culture trays 2 as shown in FIG. 3. A nutrient solution mixture supply device 14 is provided at the nutrient solution supply pipe 16. The controller 111 is connected to the nutrient solution mixture supply device 14 for controlling the nutrient solution mixture supply device 14 to mix the nutrient solution and to supply the nutrient solution to the culture trays 2. Specifically, for example, when a water level sensor detects that the water level is lower than the minimum limit threshold, it is determined, based on values detected by the nutrient solution concentration sensor at this time, that the current nutrient solution lacks of compositions, and the nutrient solution supply system 1122 automatically mixes the required quantificational nutrient solution and transmit it to the culture trays 2. The quantity meets that the water level after automatic addition of the nutrient solution is not higher than the highest limit threshold of the water level, so as to prevent the nutrient solution from overflowing the culture trays 2. In some embodiments, data regarding nutrient solution mixture is different depending on different plant growth stages. Specifically, the current growth period of plants is determined based on images acquired by the image acquiring device. Further, through settings of the growth stages, the system automatically adds nutrient solution by mixing according to mixing data instruction in the current mode, to further adapt the plant growth demands at different stages. Nutrient solution storage buckets and pure water buckets can be provided on the plant water culture frame in which the nutrient solution is nutrient solution having a general formula. The nutrient solution storage buckets are classified as storage buckets containing nitrogen nutrient solution, storage buckets containing phosphorus potassium nutrient solution, and storage buckets containing potassium nutrient solution. Although the nutrient solution supply pipe 16 is only schematically shown in FIG. 1 to reach parts of the culture trays 2, it will be appreciated by those skilled in the art that the nutrient solution supply pipe 16 can reach any or all of the culture trays 2. In addition, although the present application describes, by way of example, the air supply pipe 15 and the nutrient solution supply pipe 16 enters into the culture trays 2 through the through-holes 7 as shown in FIG. 3, it will be appreciated by those skilled in the art that, they may enter into the culture trays 2 through different through-holes or in any other ways.

The plant growth ensuring system 11 as shown in FIG. 10 also includes a communication unit 114. The controller 111 is connected to a host computer 12 through the communication unit 114. The controller 111 receives parameter information of the parameter sensor 113 and transmits it to the host computer 12 through the communication unit 114. The host computer 12 transmits to the controller 111 through the communication unit 114 a growth environment adjustment command generated based on the parameter information. The controller 111 receives the control command of the host computer 12 to control the growth environment regulation system 112 to adjust the plant growth environment. In the present disclosure, the controller 111 may be a Programmable Logic Controller (PLC). A lighting fixture 3 to provide plants with a light source can also be directly connected to the PLC, so as to achieve automatic turning on or off of the lighting fixture. As shown in FIG. 1, the controller 111 is disposed, for example, in a distribution box 4 at the bottom of the plant water culture frame 1. In some embodiments, the air pump 13 and the nutrient solution mixture supply device 14 as shown in FIG. 1 may also be located near the distribution box 4.

In the embodiments of the present disclosure, the host computer 12 may include a touch display screen 5 as shown in FIG. 2, which may be disposed on the plant water culture frame 1. Various growth parameters detected by the water temperature sensor, water level sensor, oxygen content sensor, nutrient solution concentration sensor can be transmitted to the touch screen display 5 for display. The user can use the touch display screen 5 to monitor whether the plant growth environment meets standards. In addition, the user can input control commands directly through the touch display screen 5 to transfer the commands to the controller so that the growth environment regulation system 112 adjusts the plant growth environment and ensures the plant growth environment within the culture tray 2.

In another embodiment of the present disclosure, the host computer 12 may be a remote control terminal which may be simultaneously connected to a plurality of plant growth ensuring systems for centralized control. Control and monitoring of various plant growth ensuring systems are achieved by application software in the remote control terminal. In the present disclosure, the host computer 12 may be any of electronic devices having a control function such as a PC, an IPAD, a notebook computer, a smart watch, or the like.

Specifically, for example, the remote control terminal is a smart phone. Upon the smart phone is connected to the plant growth ensuring system, applications (APPs) of the smart phone are operated and controlled to monitor growth status of plants. Various parameter data detected by various parameter sensors can be displayed on the APP in real time. Thus the user can manually and wirelessly adjust devices of the plant water culture frame based on the displayed data, including adding nutrient solution and turning on or off the oxygen pump. Plants can be timely picked and managed by analyzing and determining images acquired by the image acquiring device and by the App remotely monitoring whether the plants have come to be mature.

In view of the above, the plant water culture frame and the plant growth ensuring system provided by embodiments of the present disclosure are provided with the plant-fixed basket support component which supports plant-fixed baskets to make them float with nutrient solution, so as to keep plant root systems always in contact with the nutrient solution while height of a liquid level of the nutrient solution changes. This effectively avoids that when the liquid level of the nutrient solution is too high, the plant root systems are submerged, thus affecting normal growth of plants. The plant water culture frame provided by embodiments of the present disclosure not only has high space utilization and aesthetic outlook, but also is conducive to effectively culture pollutant-free organic vegetables, which integrates decoration with utility.

It is to be noted that, in this document, relation terms such as first and second are used only to distinguish an entity or an operation from another entity or operation, and do not necessarily require or imply that there is any such actual relationship or sequence between such entities or operations. Moreover, terms “comprising”, “including”, or any other variant thereof are intended to encompass a non-exclusive inclusion such that processes, methods, articles, or devices that include a series of elements include not only those elements but also other elements that are not explicitly listed, or elements that are inherent to such processes, methods, articles, or devices. In the absence of more restrictions, elements defined by the statement “including a . . . ” do not exclude presence of additional same elements in the processes, methods, articles, or devices that includes the elements. Orientation or position relationship indicated by terms “up”, “down”, etc. are ones shown in the drawings. This is only for the purpose of convenient description of the present disclosure and simplification of the description, and does not indicate or imply that devices or elements indicated must have specific orientation and be constructed and operated in a particular orientation, and therefore cannot be construed as limiting the present disclosure. Terms “installation”, “connection”, “connecting” should be understood in a broad sense unless otherwise explicitly specified and defined. For example, it may be a fixed connection, a detachable connection or an integral connection; may be a mechanical connection or an electrical connection; or may be a direct connection, an indirect connection through an intermediary, or internal connectivity between two elements. The specific meaning of the above terms in the present disclosure may be understood by those ordinary skilled in the art in light of specific circumstances.

A large number of specific details are set forth in the specification of the present disclosure. It is to be understood, however, that the embodiments of the present disclosure may be practiced without these specific details. In some instances, well-known methods, structures, and techniques have not been shown in detail so as not to obscure understanding of this specification. Similarly, it is to be understood that, in the above description of the exemplary embodiments of the present disclosure, the features of the present disclosure are sometimes grouped together into a single embodiment, figure, or description thereof, in order to simplify the present disclosure and to assist in understanding of one or more of various disclosure aspects. However, methods of the present disclosure should not be construed to reflect the intent that the claimed disclosure requires more features than those exactly recited in each claim. More specifically, as reflected in the claims, the disclosure is less than all of the features of the previously disclosed single embodiment. Accordingly, the claims that follow specific embodiments are thus expressly incorporated into the specific embodiments wherein each claim per se acts as an individual embodiment of the present disclosure.

Finally, it should be noted that the above embodiments are merely used for illustrating technical solutions of the present disclosure and are not intended to be limiting thereof. While the present disclosure has been described in detail with reference to the foregoing embodiments, it will be understood by those ordinary skilled in the art that, it is still possible to modify the technical solutions recited in the foregoing embodiments or to equivalently replace some or all of the technical features therein, and that these modifications or replacements do not make essence of corresponding technical solutions depart from the scope of technical solutions of the embodiments of the present disclosure, and are encompassed within the scope of the claims and the specification of the present disclosure.

1. A plant water culture frame comprising:
a frame body provided with at least one water culture space layer;
at least one culture tray provided in the water culture space and used for containing nutrient solution;
a plant-fixed basket support component provided in the culture tray and supporting a plant-fixed basket to make it floating with the nutrient solution; and
at least one plant-fixed basket provided on the plant-fixed basket support component.

2. The plant water culture frame of claim 1, wherein the plant-fixed basket support component comprises a plurality of through-holes, and the plant-fixed basket is placed on the plant-fixed basket support component by making bottom of the plant-fixed basket passing through the though-hole.

3. The plant water culture frame of claim 1, wherein an area of a cross-section of the plant-fixed basket support component is equal to that of an opening of the culture tray, and the plant-fixed basket support component is an opaque flat plate.

4. The plant water culture frame of claim 1, wherein the plant-fixed basket support component is a foam plate.

5. The plant water culture frame of claim 1, further comprising a seed support component provided within the plant-fixed basket for obtaining moisture from the culture tray and supporting a seed placed within the seed support component so as to facilitate seed germination.

6. The plant water culture frame of claim 5, wherein a seed clamped portion is disposed in the seed support component, and the seed clamped portion is configured as a gap penetrating the seed support component.

7. The plant water culture frame of claim 5, wherein a seed clamped portion is disposed in the seed support component, and the seed clamped portion includes a recess disposed in the seed support component and a gap disposed at the recess and penetrating the seed support component.

8. The plant water culture frame of claim 6, wherein a cross-section of the gap is cross-shaped.

9. The plant water culture frame of claim 5, wherein the seed support component is a sponge block.

10. The plant water culture frame of claim 1, wherein the plant-fixed basket comprises a neck portion and a waist portion, and the waist portion is a hollowed-out structure comprising a plurality of support posts.

11. The plant water culture frame of claim 10, wherein a height ratio of the neck portion to the waist portion is between 1:2 and 1:3.

12. The plant water culture frame of claim 1, wherein a height ratio of the plant-fixed basket to plant-fixed basket support component is larger than 1.1:1 or less than 1.5:1.

13. The plant water culture frame of claim 1, wherein a lighting fixture simulating a wavelength of sunlight is provided on the top of the water culture space.

14. The plant water culture frame of claim 13, wherein the lighting fixture comprises a white LED light source coated with red phosphor.

15. A plant growth ensuring system for use in the plant water culture frame of claim 1, comprising:
a parameter sensor provided in the culture tray of the plant water culture frame for detecting a parameter of a plant growth environment in the culture tray;
a growth environment regulation system for regulating the plant growth environment in the culture tray; and
a controller, wherein the parameter sensor and the growth environment regulation system are connected to the controller, and the controller generates a growth environment adjustment command according to a growth environment parameter sensed by the parameter sensor so as to control the growth environment regulation system to adjust the plant growth environment in the culture tray.

16. The plant growth ensuring system of claim 15, wherein the parameter sensor comprises one or more of a water temperature sensor, a water level sensor, an oxygen content sensor, a nutrient solution concentration sensor, a light sensor, and an image acquiring device.

17. The plant growth ensuring system of claim 15, wherein the growth environment regulation system comprises an air supply system including an air supply pipe provided at the culture tray; an air pump is provided at the air supply pipe; and the controller is connected to the air pump for controlling the air pump to introduce oxygen into the culture tray.

18. The plant growth ensuring system of claim 17, wherein the parameter sensor comprises an oxygen content sensor, and when the oxygen content sensor detects that oxygen content in the nutrient solution within the culture tray is below a limit threshold, the air supply system would automatically turn on the air pump for oxygen supply.

19. The plant growth ensuring system of claim 15, wherein the growth environment regulation system comprises a nutrient solution supply system comprising a nutrient solution supply pipe provided at the culture tray; a nutrient solution mixture supply device is provided at the nutrient solution supply pipe; and the controller is connected to the nutrient solution mixture supply device for controlling the nutrient solution mixture supply device to mix the nutrient solution and to supply the nutrient solution to the culture tray.

20. The plant growth ensuring system of claim 15, further comprising a communication unit; and wherein the controller is connected to a host computer through the communication unit; the controller receives parameter information of the parameter sensor and transmits the parameter information to the host computer through the communication unit; the host computer transmits to the controller through the communication unit a growth environment adjustment command generated according to the parameter information; and the controller receives the growth environment adjustment command of the host computer to control the growth environment regulation system to adjust the plant growth environment in the culture tray.
